(19) United States
(12) Patent Application Publication
(10) Pub. No.: US 2006/0193711 A1
(43) Pub. Date: Aug. 31, 2006

(54) Threaded bolt fastener

(76) Inventor: Gino Dominico Mario Ashley Di-Mola, Leicester (GB)

Correspondence Address: PIETRAGALLO, BOSICK & GORDON, ONE OXFORD CENTRE, 38TH FLOOR, 301 GRANT STREET, PITTSBURGH, PA, 15219-6404, US

(21) Appl. No.: 10/543,223

(22) PCT Filed: Dec. 24, 2003
(86) PCT No.: PCT/GB03/05633

§ 371 Date: Mar. 30, 2006

(30) Foreign Application Priority Data
Jan. 22, 2003 (GB) 0301414.9

(51) Int. Cl. F16B 39/02

(52) U.S. Cl. 411/271

(57) ABSTRACT

The invention provides a threaded fastener such as a bolt for engagement with a uniform cylindrical screw-thread of a threaded bore or nut. The sleeve (4) of the fastener, or shank of the bolt, has a diameter less than the smallest internal diameter of the uniform cylindrical screw-thread of the bore or nut of which the fastener is to be used, and initially the diameter of that sleeve is constant throughout the whole of its axial length. A taper screw-thread (7) is cut into one cylindrical end portion of the sleeve (4), and that end portion is axially divided by slots (9) into segments (10) which can be spread apart by expansion means such as a spreader pin (2). The external screw-thread cut into the cylindrical end portion of the sleeve (4) is of constant pitch and initially has an effective diameter which increases from the end of the sleeve (4) through the segmented portion, but after expansion of the segments (10) the external screw-thread is brought to a single effective diameter to mate with the threaded bore or nut.

### FIELD OF INVENTION

The invention relates to a threaded bolt fastener for engagement with a uniform cylindrical internal screw thread. More particularly, the invention relates to a threaded bolt fastener that is relatively quick and easy to locate alongside a uniform cylindrical internal screw thread such that its threads do not engage with those of the internal screw thread until the fastener is in a desired position. The external screw threads of the fastener can then be expanded to bring them into secure threaded engagement with the internal screw thread.

### BACKGROUND ART

Conventional nuts and bolts are generally used in combination to secure or fasten structural elements together. A bolt generally has a relatively large head and, stemming from that head, a relatively long and thin shank. The shank is usually provided with a uniform screw thread on its outer surface extending along at least a portion of the shank's length. Quite often, the screw thread extends the entire length of the shank.

If the bolt fastener is to be inserted into an internally screw-threaded bore, distortions to or interruptions in the thread of the bore caused by previous damage can make it difficult to screw the bolt fully into the bore. Even when the screw-thread of the bore is undamaged, it can be tedious to have to run the bolt down the bore possibly for some considerable depth until the bolt head engages the outer structural element to be secured by the bolt fastener. Our Patent Specification WO 02/08617 discloses an expandable threaded bolt fastener which has a segmented threaded shank which can be inserted fully into the threaded bore without engaging the screw-threads of that bore, optionally by-passing any damaged thread portions of the bore, and then expanded to bring the screw-threads of the shank into threaded engagement with the screw-threads of the bore.

Many other proposals for an expandable threaded shank of a bolt are known, for example U.S. Pat. No. 1,409,817, U.S. Pat. No. 3,159,075, U.S. Pat. No. 5,755,543 and U.S. Pat. No. 3,202,194. All involve a segmented shank which has a cylindrical outer shape into which is cut a screw-thread of uniform depth and pitch. In WO 02/08617 the shank is then deformed from a cylindrical outer shape to an inwardly tapering shape so that the screw-threads can by-pass the internal threads of the bore into which the bolt fastener is to be inserted, but is then expanded to the cylindrical shape after insertion. U.S. Pat. No. 3,202,194 is designed as a self-locking bolt and therefore is initially deformed to an outwardly tapering shape by a compressible wedge, and on screwing it into the threaded bore the wedge is compressed and the bolt resumes its cylindrical outer profile but in frictional locking engagement with the threaded bore. U.S. Pat. No. 3,202,194 therefore requires a reducing taper at the very end of the threaded shank, to be started into threaded engagement with the bore.

It is an object of the invention to provide a threaded bolt fastener which is of simpler construction than the known fasteners and which is cheaper to fabricate, while maintaining all of the advantages of WO 02/08617.

### THE INVENTION

The invention provides a threaded fastener having the features of claim 1. Because the screw-thread is taper-cut into the cylindrical end portion of the sleeve, the outer diameter of the sleeve can be constant over its entire length until the actual screw-thread cutting operation. That represents a considerable saving in time and materials over prior art proposals which either have cut a cylindrical screw-thread into a cylindrical outer surface of a bolt and then segmented the threaded end and bent the segments inwardly, or have cut a taper thread into a tapering end of a bolt prior to segmenting the threaded end.

The tooth form of the external screw thread cut into the cylindrical end portion of the cylindrical sleeve may be any tooth form, such as triangular or square, so long as it mates with the internal tooth form of the screw-threaded bore or nut when the segments are expanded within the bore or nut.

Preferably the screw-thread taper-cut into the end of the hollow sleeve extends for an axial extent approximately equal to the axial length of the segmented end of the sleeve. The length of the segment end portion is suitably from 1 to 3 times the diameter of the hollow sleeve, preferably about twice the diameter.

Preferably, the hollow sleeve has a diameter less than the smallest internal diameter of the uniform cylindrical thread or the bore or nut into which the fastener is intended to be placed. The bore or nut is not part of the invention.

The expansion means may be a spreader pin which may be forced into the hollow interior of the sleeve for example by a hammer blow. The pin sidably engages with a tapering end wall of the hollow interior of the sleeve to force the segment apart. The spreader pin may have a head and a solid cylindrical body, or may be a simple headless cylindrical pin. Releasable locking means as disclosed in WO 02/08617 may be provided between the spreader pin and the internal surface of the sleeve to resist movement of the spreader pin out of the hollow interior of the sleeve once it has spread apart the segments to bring their taper cut external screw threads into engagement with the uniform cylindrical screw-thread of the threaded bore or nut. Alternatively tight frictional engagement between the pin and the internal surface of the sleeve may achieve the same end.

Instead of the spreader pin being axially movable long the hollow interior of the sleeve by a hammer blow as described above, the pin and sleeve may be provided with complementary screw-threads so that the spreader pin becomes a spreader bolt or expansion bolt which can be rotated to drive it in either axial direction along the hollow interior of the sleeve. Initial movement in a segment-expanding direction causes the segments to spread apart to bring their taper-cut external screw-threads into threaded engagement with the internal thread of the bore or nut. A further axial movement of the spreader bolt in the same direction preferably compresses the segments against the internal screw-threaded wall of the bore or nut, so as to lock the threaded fastener to the bore or nut as described and claimed in British Patent Application No. 0301418.0 (Publication No. 2388882) filed herewith in the name of Advanced Bolting Solutions Ltd.

Another aspect of the invention provides for, a method of manufacturing a threaded fastener including the step of taper-cutting a screw thread into a cylindrical end portion of the hollow sleeve.

In yet another aspect of the above named method, there is the subsequent step of axially segmenting the end portion.

In another aspect of the invention, a method of using the fastener according to the invention, including the steps of

selecting a fastener with a hollow sleeve diameter less than the smallest internal diameter of the uniform cylindrical screw thread of the bore or nut which is to receive the fastener;

advancing the fastener along the bore or into the nut;

positioning the fastener in the required position within the bore or nut; and

moving the expansion means axially along the hollow interior of the sleeve, to engage an internal surface of the externally screw-threaded and segmented end and to spread apart the segments so that the external screw threads thereof are brought into screw threaded engagement with the internal cylindrical screw thread of the screw threaded bore or nut.

### DRAWINGS

In the schematic drawings,

FIG. 1 is a side elevation of the two components of a threaded fastener according to the invention;

FIG. 2 is an axial section through the assembled fastener of FIG. 1, before expansion of the segmented end of its hollow sleeve and;

FIG. 3 is an axial section through the fastener after expansion of its segmented end.

The threaded fastener of the drawings comprises a hollow shafted bolt 1 and a spreader pin 2. Bolt 1 comprises a head 3 and a hollow cylindrical sleeve 4. The head 3 may have any desired external profile, such as square or hexagonal to enable it to be gripped using conventional spanners.

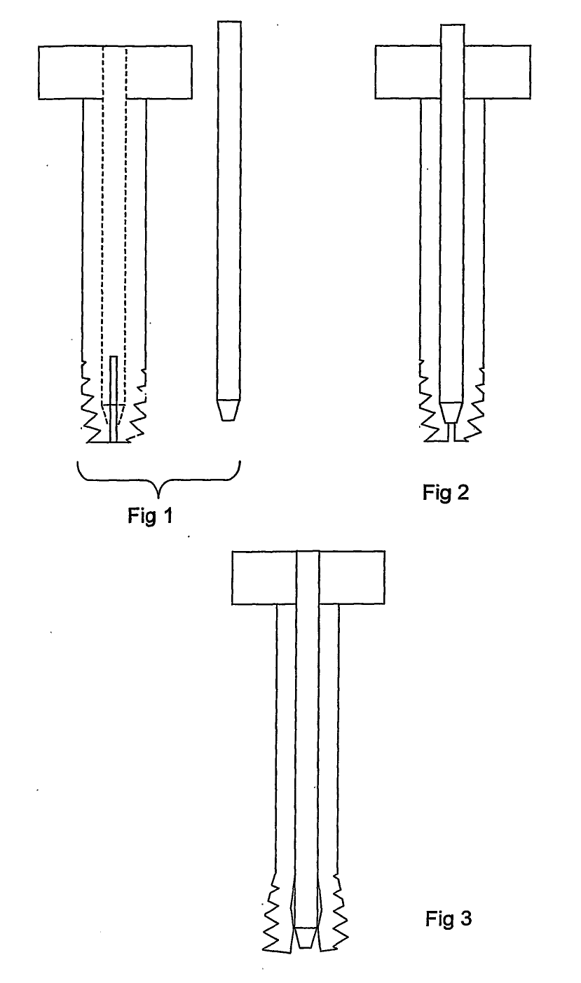

The hollow interior of the sleeve 4 is defined by a blind bore 5 extending from the head 3 and terminating in an inwardly blind end 6. Initially the hollow sleeve 4 is cylindrical throughout the whole of its length, but into the cylindrical end remote from the head 3 is cut a tapering screw-thread 7. Because the screw-thread 7 is cut on the taper, the teeth cut into the distal end of the sleeve 4 are cut more deeply than those cut nearer to the head 3. The effective diameter of the screw-thread cut into the cylindrical end portion of the sleeve 4 thus increases from the end of the cylindrical sleeve 4 throughout the screw-threaded portion. FIG. 1 shows, by the addition of an imaginary line 8, the line of the effective diameter of the taper cut screw-thread which forms an angle α with the axes of the sleeve 4.

Although the sequential teeth shown in plan view in FIG. 1 and in section in FIG. 2, cut progressively less deeply into the cylindrical end of the hollow sleeve 4 in the direction from the end of the sleeve 4 towards the head 3, the pitch between successive teeth is constant throughout the spiral cut screw-thread. One or more axial slots 9 are formed in the taper-cut screw-threaded end of the hollow sleeve 4, dividing the screw-threaded end portion into a number of angularly spaced segments 10. One slot 9 is sufficient to divide the screw-threaded end into two segments; two mutually perpendicular slots 9 would divide the same end into four angularly spaced segments; and three equally spaced slots would divide the said end into six angularly spaced segments. Preferably the slots 9 are formed after the cutting of the screw-thread 7, and preferably the axial length of the screw-threaded and segmented end of the hollow sleeve 4 is equal to from 1.5 to 2.5 times its diameter.

FIG. 2 shows the spreader pin 2 in position inside the blind bore 5 of the bolt. In this preliminary configuration, the bolt can be dropped into a depth threaded bore, or can be used to assemble a stack of apertured components before loosely receiving a nut (not shown) at its lower end. At this stage, there is no engagement between the taper-cut thread lower end of the bolt 1 and the internal screw-thread of the bore or nut, because the external diameter of the hollow sleeve, including its taper-cut threaded end, is less than the smallest diameter of the uniform cylindrical screw-thread of the bore or nut. When the spreader pin 2 is tapped with a hammer, it moves to the position shown in FIG. 3, sliding down the taper of the blind end 6 of the bore 5 and spreading apart the segmented end portions 10 as shown in FIG. 3.

FIG. 3 shows how the spreading apart of the segments 10 results in the creation of a constant effective diameter for the teeth 7. This permits strong engagement with the internal screw-thread of the threaded bore or nut, that engagement having been established by a minimum of cutting and post-forming of the threaded fastener.

1. A threaded fastener for engagement with a uniform cylindrical screw thread of a threaded bore or nut, the threaded fastener including:
a hollow sleeve with a terminal end having an external screw thread of constant pitch cut into one cylindrical end portion thereof proximal to the terminal end, the screw-threaded end portion being axially divided into a plurality of angularly spaced segments; and
expansion means axially movable along the hollow interior of the sleeve after insertion of the fastener into the bore or nut, to engage an internal surface of the externally screw-threaded and segmented end and to spread apart the segments so that the external screw threads thereof may be brought into screw threaded engagement with the internal cylindrical screw thread of the screw threaded bore or nut;
characterized in that the external screw thread is a taper thread cut into the cylindrical end portion of the cylindrical sleeve so that the turns of the external screw thread furthest from the terminal end are cut progressively less deeply.

2. A threaded fastener according to claim 1, wherein after spreading apart the segments by movement of the expansion means along the hollow interior of the sleeve, the external screw threads of the spread-apart segments have a constant effective diameter.

3. A threaded fastener according to claim 1 or claim 2, wherein the expansion means is a spreader pin which is receivable in the hollow sleeve to slidably engage with an inner surface of each segment.

4. A threaded fastener according to claim 3, wherein the spreader pin comprises a head and a solid cylindrical body.

5. A threaded fastener according to claim 3, further comprising releasable locking means provided between the spreader pin and the internal surface of the sleeve to resist movement of the spreader pin out of the hollow interior of the sleeve once it has spread apart the segments to bring their external screw threads into screw engagement with the uniform cylindrical screw thread of the threaded bore or nut.

6. A threaded fastener according to claim 3, wherein the spreader pin is brought into tight frictional engagement with the internal surface of the sleeve to resist movement of the spreader pin out of the hollow interior of the sleeve once it has spread apart the segments to bring their external screw threads into screw engagement with the uniform cylindrical screw thread of the threaded bore or nut.

7. A threaded fastener according to any of claims 3 to 6, wherein the spreader pin is screw-threaded to an internal screw thread formed in the internal surface of the hollow sleeve, and is advanced along the sleeve by turning it using a turning tool applied to a key recess at one end of the spreader pin.

8. A threaded fastener according to claim 7, wherein the key recess is a slot and the turning tool is a screwdriver.

9. A threaded fastener according to claim 7, wherein the key recess is a hexagonal recess and the turning tool is a hexagonal key.

10. A method of manufacturing a threaded fastener according to any preceding claim, including the step of:
taper-cutting a screw thread into a cylindrical end portion of the hollow sleeve.

11. A method according to claim 10, including the subsequent step of axially segmenting the end portion.

12. A method of using a fastener according to any of claims 1 to 9, including the steps of:
selecting a fastener with a hollow sleeve diameter less than the smallest internal diameter of the uniform cylindrical screw thread of the bore or nut which is to receive the fastener; advancing the fastener along the bore or into the nut;
positioning the fastener in the required position within the bore or nut; and
moving the expansion means axially along the hollow interior of the sleeve, to engage an internal surface of the externally screw-threaded and segmented end and to spread apart the segments so that the external screw threads thereof are brought into screw threaded engagement with the internal cylindrical screw thread of the screw threaded bore or nut.
